(19) United States
(12) Patent Application Publication
(10) Pub. No.: US 2010/0239391 A1
(43) Pub. Date: Sep. 23, 2010

(54) Bookbinding device, system, and method

(75) Inventors: Takeshi Sasaki, Tokyo (JP); Junichi Iida, Kawasaki-shi (JP); Shingo Matsushita, Tokyo (JP); Satoshi Saito, Kawasaki-shi (JP); Ikuhisa Okamoto, Sagamihara-shi (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/659,436

(22) Filed: Mar. 9, 2010

(30) Foreign Application Priority Data
Mar. 18, 2009 (JP) 2009-066681
Sep. 30, 2009 (JP) 2009-227314

(51) Int. Cl. B42B 5/08

(52) U.S. Cl. 412/6; 412/38

(57) ABSTRACT

A bookbinding device includes a punch unit to punch a line of ring holes, an aligning unit disposed downstream from the punch unit in the sheet transport direction, including a pair of first aligning members to align a first sheet, each including a sheet loading surface and a side wall perpendicular to the sheet loading surface, and a pair of rotatable second aligning members, each including a lower surface facing the sheet loading surface of the first aligning member and a contact surface perpendicular to the lower surface to align a second sheet smaller than the first sheet, a swing shaft extending perpendicular to the sheet transport direction, rotatably supporting the second aligning members, a driving source to rotate the second aligning members away from and toward the sheet loading surfaces of the first aligning members, and a ring-binding unit.

### CROSS-REFERENCE TO RELATED APPLICATIONS

This patent specification is based on and claims priority from Japanese Patent Application Nos. 2009-066681, filed on Mar. 18, 2009, and 2009-227314, filed on Sep. 30, 2009 in the Japan Patent Office, each of which is hereby incorporated by reference herein in its entirety.

### BACKGROUND OF THE INVENTION

1. Field of the Invention

The present invention generally relates to a bookbinding device connected to an image forming apparatus such as a copier, a printer, a facsimile machine, or a multifunction machine capable of at least two of these functions, a bookbinding system including a bookbinding device and an image forming apparatus, and a bookbinding method.

2. Discussion of the Background Art

At present, finishers to perform post-processing, such as aligning, sorting, stapling, punching, and/or bookbinding, of multiple sheets of recording media discharged from image forming apparatuses, such as copiers, printers, facsimile machines, or multifunction devices including at least two of these functions, are widely used. Bookbinding includes stitching one edge portion or a center portion of a batch of sheets, attaching adhesive tape to one edge of the batch of sheets, and punching an end portion of the sheets and then binding together the sheets into a book using a metal coil, a plastic ring binder, or the like.

Certain conventional finishers connected to image forming apparatuses can only punch multiple punch holes into each sheet along a side to be bound (hereinafter “bound side”) one sheet at a time, arrange the multiple sheets in sequential order, and then discharge the multiple sheets to a discharge tray without binding. Then, end users must bind together the sheets thus discharged with a binder such as metal or plastic rings or coils (hereinafter “ring member”) using an offline bookbinding device (e.g., ring-binding device) or by manually binding them using tools.

By contrast, certain known sheet processing systems have multiple sheet processing devices, such as a punch unit, a stapler, and the like, connected in series to an image forming apparatus and automatically perform aligning, sorting, stapling, and/or punching, of sheets of recording media on which images are formed by the image forming apparatus.

Recently, bookbinding devices that can perform ring binding online (i.e., automatically) have come to be used, which can improve the productivity of sheet processing significantly.

For example, certain known bookbinding devices include a transport unit to transport sheets to a predetermined position and an aligning unit to align and store temporally multiple sheets transported by the transport unit. The aligning unit includes a paddle roller unit to align a leading edge and a side of the multiple sheets with respective reference positions. The paddle roller unit has a double-fin structure formed with a rotary body and a multilayered fin provided around the rotary body, with multiple fins each having a predetermined thickness and a predetermined degree of flexibility.

Although there are convenient online bookbinding devices, there are cases in which bookbinding cannot be executed online. For example, it is possible that a front cover and a back cover are larger than the sheets to be bound together therebetween to protect the sheets to be bound and to improve the appearance of the book. However, the above-described known bookbinding devices cannot align and bind together such multiple differently-sized sheets automatically.

Therefore, there is a need for a bookbinding device capable of binding together multiple differently-sized sheets automatically, which known approaches fail to do.

### SUMMARY OF THE INVENTION

In view of the foregoing, one illustrative embodiment of the present invention provides a bookbinding device to bind together multiple sheets of recording media including a first sheet and a second sheet smaller than the first sheet in a width direction perpendicular to a sheet transport direction in which the sheets are transported.

The bookbinding device includes a punch unit to form a line of ring holes in a predetermined portion along a side of a respective one of the multiple sheets, an aligning unit disposed downstream from the punch unit in the sheet transport direction to align the multiple sheets punched by the punch unit in the width direction, and a ring-binding unit disposed adjacent to the aligning unit to insert rings of the ring member into the ring holes formed in the multiple sheets.

The aligning unit includes a pair of first aligning members, a pair of second aligning members, a swing shaft extending perpendicular to the sheet transport direction, rotatably supporting the second aligning members, and a driving source to rotate the second aligning members. Each of the first aligning members includes a sheet loading surface to support the multiple sheets and a side wall perpendicular to the sheet loading surface, to align the first sheet by contacting a side edge portion of the first sheet in parallel to the sheet transport direction. Each of the second aligning members includes a lower surface facing the sheet loading surface of the first aligning member and a contact surface perpendicular to the lower surface. The contact surface aligns the second sheet smaller than the first sheet by contacting a side edge portion of the second sheet in parallel to the sheet transport direction. The driving source rotates the second aligning members away from the sheet loading surfaces of the first aligning members when the first aligning member align the first sheet and rotates the second aligning members toward the sheet loading surfaces of the first aligning members when the second aligning members align the second sheet.

Another illustrative embodiment provides a bookbinding system including an image forming apparatus to form an image on a sheet and the bookbinding device described above.

Yet another illustrative embodiment provides a method of binding together multiple differently-sized sheets using a bookbinding device including a punch unit, a pair of first aligning members, and a pair of second aligning members disposed inside the first aligning members in a width direction perpendicular to a direction in which the multiple sheets are transported.

The method includes forming a line of ring holes in a predetermined portion along a side of a respective one of the multiple sheets, rotating the second aligning members upward, aligning a first sheet in the width direction using the first aligning members, rotating the second aligning members downward, stacking a second sheet and any subsequent sheets smaller than the first sheet on the aligned first sheet, aligning the second sheet and the subsequent sheets smaller than the first sheet in the width direction using the second aligning members, and binding together the multiple sheets with a ring member.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a front view illustrating a configuration of a bookbinding system according to an illustrative embodiment of the present invention;

FIG. 2 illustrates a configuration of a ring-binding device;

FIG. 3 illustrates a state before a pin member aligns multiple sheets with each other relative to ring holes;

FIG. 4 illustrates a state after the pin member aligns the multiple sheets with each other relative to the ring holes;

FIG. 5 is a perspective view illustrating a configuration of an auxiliary fence included in a transverse jogger according to an illustrative embodiment;

FIG. 6 is a perspective view illustrating main components of a driving system to drive the auxiliary fence;

FIGS. 7A and 7B schematically illustrate movement of one of a right fence and a left fence of the auxiliary fence;

FIG. 8 is a perspective view illustrating a driving system of the transverse jogger; and

FIG. 9 is a perspective view illustrating an appearance of multiple sheets bound together into a book by the ring-binding device shown in FIG. 2.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

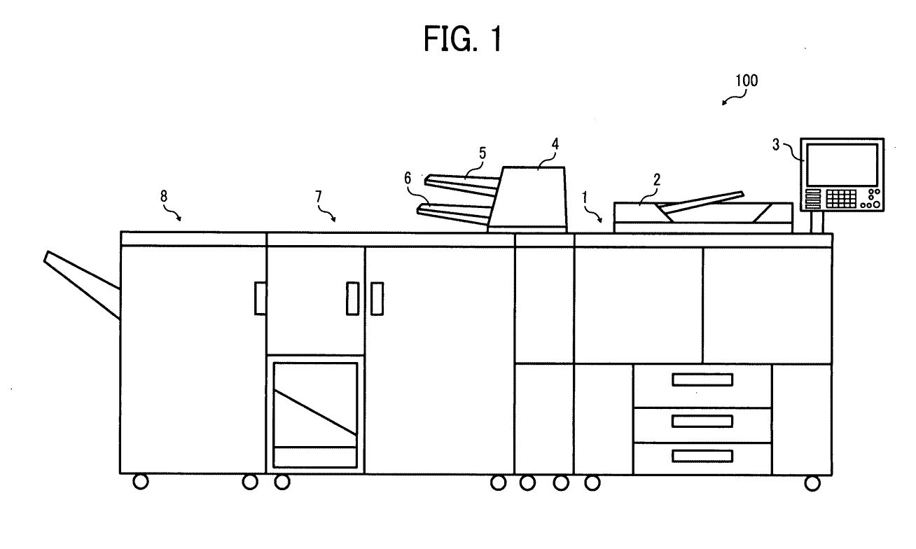

Referring now to the drawings, wherein like reference numerals designate identical or corresponding parts throughout the several views thereof, and particularly to FIG. 1, a bookbinding system according to an illustrative embodiment of the present invention is described.

FIG. 1 is a front view illustrating exterior of a bookbinding system 100 according to an illustrative embodiment of the present invention.

The bookbinding system 100 includes an image forming apparatus 1 that in the present embodiment is a digital multifunction machine capable of at least two of copying, printing, and facsimile transmission (hereinafter “MFP 1”), an inserter 4, a ring-binding device 7, and a finisher 8 connected in series.

The MFP 1 includes an automatic document feeder (ADF) 2 and an operation panel 3 provided with a display.

The inserter 4 is disposed downstream from the MFP 1 in a direction in which sheets of recording media discharged from the MFP 1 are transported in the bookbinding system 100 shown in FIG. 1 (hereinafter “sheet discharge direction”). The inserter 4 includes two sheet trays 5 and 6 to store sheets and feeds the sheets to the ring-binding device 7 or the finisher 8. For example, on the sheet trays 5 and 6, sheets on which images have been formed, sheets on which no images are formed by the MFP 1, or sheets that the MFP 1 cannot accommodate are placed. Such sheets can be inserted in a batch of sheets to be bound together by the ring-binding device 7 or the finisher 8.

The ring-binding device 7 is disposed downstream from the inserter 4 in the sheet discharge direction, and the finisher 8 is disposed downstream from the ring-binding device 7. In the bookbinding system 100 shown in FIG. 1, the ring-binding device 7 can punches, aligns, and then binds together a batch of sheets into a book with a ring binder (hereinafter also “ring member”) automatically.

The finisher 8 can perform post-processing, such as aligning, sorting, stapling, and punching one through four punch holes, for example, through a known method although descriptions thereof are omitted.

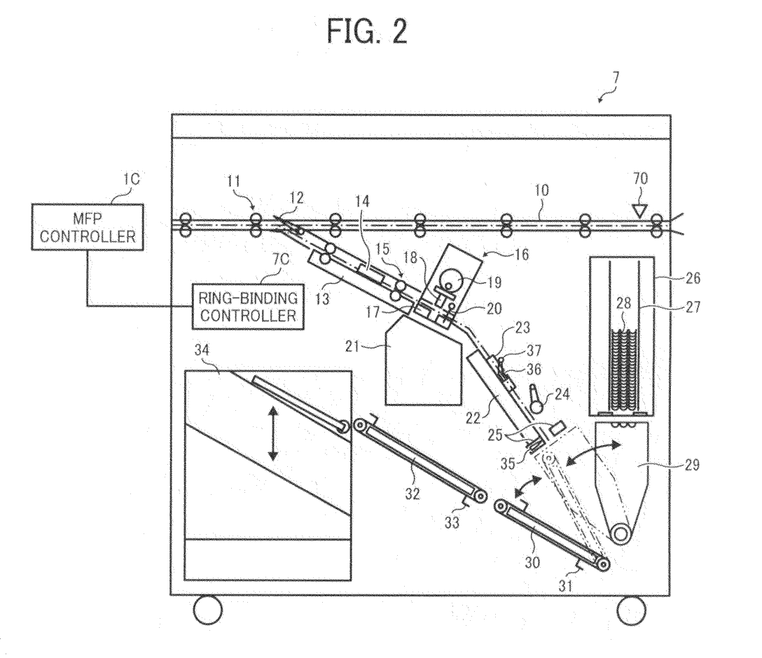

FIG. 2 is a front view illustrating a configuration of the ring-binding device 7 in detail. The ring-binding device 7 performs ring binding online. The configuration and operations of the ring-binding device 7 are described below.

A procedure of online-bookbinding according to the present embodiment is described below with reference to FIGS. 1 and 2. For example, the user can select bookbinding using the operation panel 3 of the MFP 1 or via computers, not shown. The MFP 1, the inserter 4, the ring-binding device 7, and the finisher 8 can communicate with each other.

The user can select sheets set in the inserter 4 as covers of a batch of sheets (inserted sheets) output from the MFP 1. The user may input via the operation panel 3 or the computer whether the size of the covers transported from the inserter 4 is different from that of the sheets output from the MFP 1. Alternatively, the ring-binding device 7 may includes a sheet size detector 70 disposed along the sheet transport path. A ring-binding controller 7C of the ring-binding device 7 can control respective portions including the transverse joggers 14 and 23 according to the sizes of the inserted sheets and the cover sheets obtained via an MFP controller 1C of the MFP 1 or based on the detection of the sheet size detector 70.

Next, the configuration of the ring-binding device 7 is described below in further detail with reference to FIG. 2.

The ring-binding device 7 includes a horizontal transport path 10, aligning trays 13 and 22, a hinged transport unit 30, a downstream transport unit 32, and a stack tray 34 disposed in that order in a direction in which the sheet is transported (hereinafter “sheet transport direction”) in the ring-binding device 7. The ring-binding device 7 further includes a clamp 25 and a ring-binding unit 29. The sheet output from the MFP 1 is transported along the horizontal transport path 10 in the ring-binding device 7. The sheet is horizontally transported to the finisher 8 when ring binding is not performed. When ring binding is to be performed, the sheet is reversed by a reverse roller 11 disposed in a downstream portion of the horizontal transport path 10 in the sheet discharge direction. Then, a switch pawl 12 disposed along the horizontal transport path 10 changes a route of the sheet, and the sheet is transported obliquely downward to a punch part including the aligning tray 13, a punch unit 16, a jogger 14 disposed above the aligning tray 13, a pair of transport rollers 15, and a stopper 20 disposed downstream from the aligning tray 13. The punch unit 16 includes a die 17, a punch 18, and a cam 19. It is to be noted that multiple pairs of rollers are provided along the horizontal sheet transport path 10 and other sheet transport paths to transport the sheet through the sheet transport paths.

In the punch part, when the sheet is placed on the aligning tray 13, the jogger 14 aligns the sheet in a transverse direction or width direction, perpendicular to the sheet transport direction.

The transport rollers 15 transport the sheet so that a leading edge portion of the sheet contacts the stopper 20 disposed downstream from the aligning tray 13, projecting into the sheet transport path, and thus a position of the sheet is fixed in the sheet transport direction. In other words, the position of the sheet in both the transverse direction and the sheet transport direction is fixed on the aligning tray 13 by the jogger 14 and the stopper 20. It is to be noted that the sheet is not damaged when contacting the stopper 20 because the transport rollers 15 are provided with a torque limiter.

Subsequently, the sheet is punched by the punch unit 16. The punch unit 16 punches multiple ring holes (punch holes) for ring binding. When the sheet is positioned by the jogger 14 and the stopper 20, a part of the sheet is on the die 17. In this state, the cam 19 rotates to push the punch 18 down, and thus multiple punch holes arranged in a row at predetermined or given constant intervals are formed in the sheet disposed between the die 17 and the punch 18. In this embodiment, the punch holes are lined along the transverse direction perpendicular to the sheet transport direction.

Each punch hole is formed at a predetermined or given distance from the stopper 20. After the sheet is thus punched, the stopper 20 is released to forward the sheet downstream in the sheet transport direction to an aligning section. Chads generated by punching are held in a punch chad container 21 disposed beneath the punch unit 16.

The aligning section (aligning unit) receives a batch of sheets to be bound together one by one and stacks the sheets on the aligning tray 22 while aligning them.

The aligning tray 22 is provided with a transverse jogger 23 (first aligning member) and a roller 24 that pushes the sheet in the sheet transport direction. While the roller 24 pushes the sheets against a fence (not shown), aligning the sheet in the sheet transport direction, the transverse jogger 23 aligns the sheets in the transverse direction or width direction.

An auxiliary fence 36 (second aligning member) is provided inside the transverse jogger 23 in the width direction so that multiple differently-sized sheets to be bound together can be aligned. Thus, for example, even when the cover sheet and the back cover of a batch of sheets are larger then the sheets sandwiched therebetween, the transverse jogger 23 can align them.

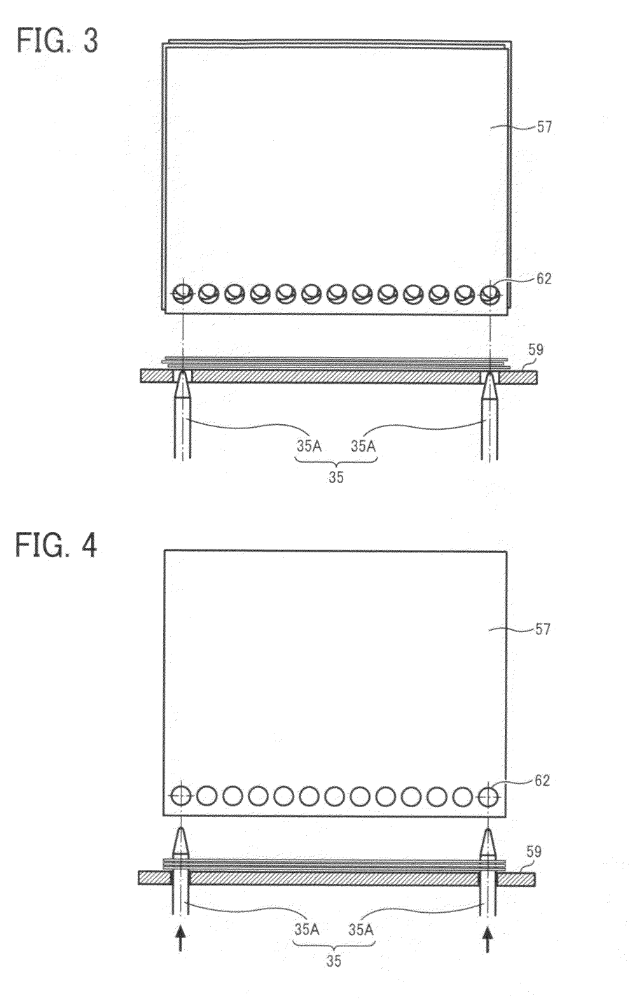

The aligning section further includes an aligning pin member 35 (shown in FIGS. 3 and 4) including at least one pin portion 35A, serving as a pin, that penetrates one of the multiple punch holes formed in the multiple sheets to improve alignment of sheets relative to the punch holes after all of the sheets to be bound together are stacked on the aligning tray 22. In the configuration shown in FIG. 3, the aligning pin member 35 includes two pin portions 35A (edge portion of the aligning pin 35) that are tapered, and the multiple sheets can be aligned as the pin portions 35A are inserted into the two punch holes.

By aligning the sheets relative to the punch holes, the sheets can be aligned reliably even when sizes of the sheets are different.

FIGS. 3 and 4 illustrate states before and after the aligning pin member 35 aligns punch holes (ring holes) 62 formed in a batch of sheets 57, respectively. Referring to FIGS. 3 and 4, an upper side of the aligning tray 22 serves as an alignment base 59, and the aligning pin member 35 includes multiple pin portions 35A that projects through pin holes formed in the aligning base 59 from beneath. After the batch of sheets 57 in which the multiple punch holes 62 are formed is aligned in the aligning section, the pin portions 35A of the aligning pin member 35 engage the respective punch holes 62, thereby aligning the batch of sheets 57 relative to the punch holes 62. In the state shown in FIG. 3, the pin portions 35A of the aligning pin member 35 does not project from the alignment base 59. After the trailing edge of the batch of sheets 57 is aligned, the pin portions 35A rise from the state shown in FIG. 3 above the alignment base 59 and engage the respective punch holes 62 as shown in FIG. 4. At that time, even when the punch holes 62 of the multiple sheets are not fully aligned with each other, the pin portions 35A can engage the respective punch holes 62 because the pin portions 35A are tapered. Thus, the batch of sheets 57 is aligned relative to the punch holes 62. It is to be noted that, although FIGS. 3 and 4 illustrate a case in which the size of the front caver and the back cover is identical or similar to that of the sheets inserted therebetween, the aligning pin member 35 is usable even when the sizes of the front cover, the back cover, and the inserted sheets are different because the punch holes 62 are formed in identical or similar positions among those sheets.

Next, ring binding is described below with reference to FIG. 2.

After a batch of sheets are aligned on the aligning tray 22, the clamp 25 presses and holds one edge portion of the sheets on the side to be bound (hereinafter “bound side”). The ring-binding device 7 further includes a ring cartridge holder 26 that is disposed close to the aligning tray 22 and holds a ring cartridge 27 containing multiple ring members 28. In the present embodiment, the ring member 28 is formed with plastic and includes a bar to which multiple rings are attached, and each ring is divided into three portions that are connected so as to be openably closable. While the clamp 25 thus holds a batch of sheets, the ring-binding unit 29 swings to a position under the ring cartridge 27 to receive one of the ring members 28, swings back to under the clamp 25 with the ring member 28, and then puts the rings of the ring member 28 into the respective ring holes formed on the sheets.

After the sheets are thus bound with the ring member 28 (hereinafter “ring-bound sheets”), the transport unit 30 swings to under the clamp 25. Then, the clamp 25 is released, and thus the ring-bound sheets are placed on the transport unit 30, received by a release pawl 31 provided on a belt of the transport unit 30. Subsequently, the transport unit 30 swings counterclockwise in FIG. 2 to align with the downstream transport unit 32. Then, the release pawl 31 forwards the ring-bound sheets to the downstream transport unit 32 that is provided with a release pawl 33. Then, the release pawl 33 discharges the ring-bound sheets onto the stack tray 34. Thus, a sequence of ring-binding operations is completed.

It is to be noted that, in FIG. 2, reference number 37 represents a swing axis of the auxiliary fence 36.

The auxiliary fence 36 is described in further detail below.

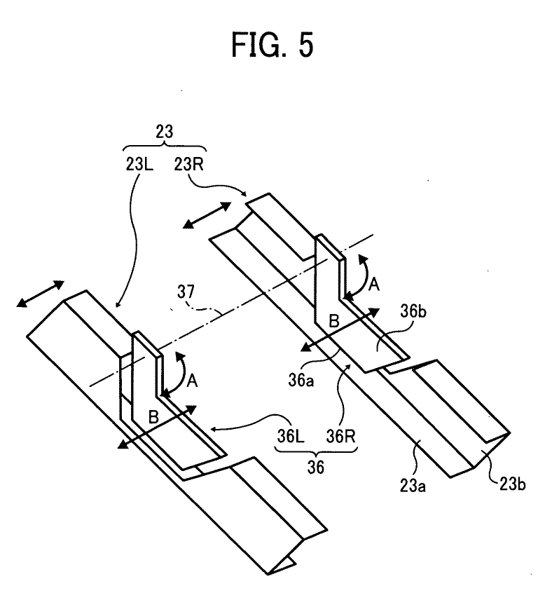

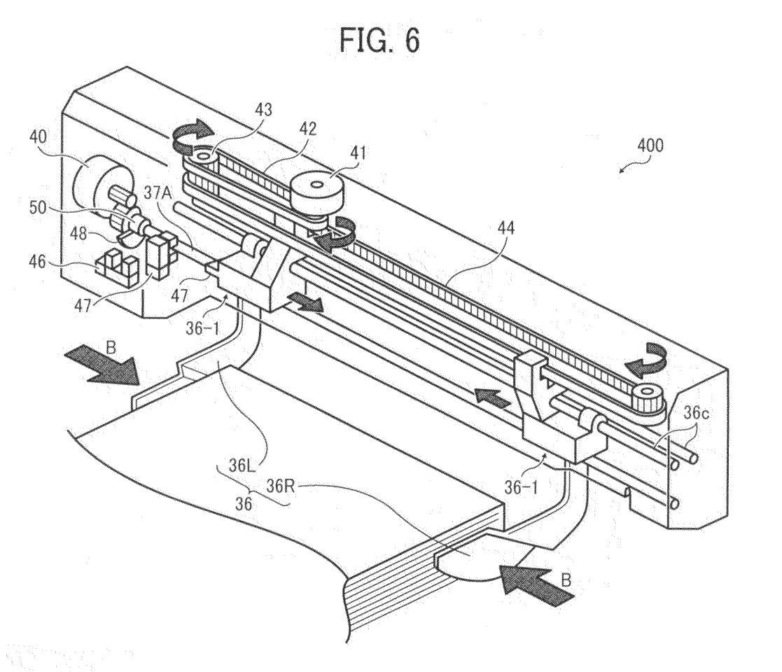

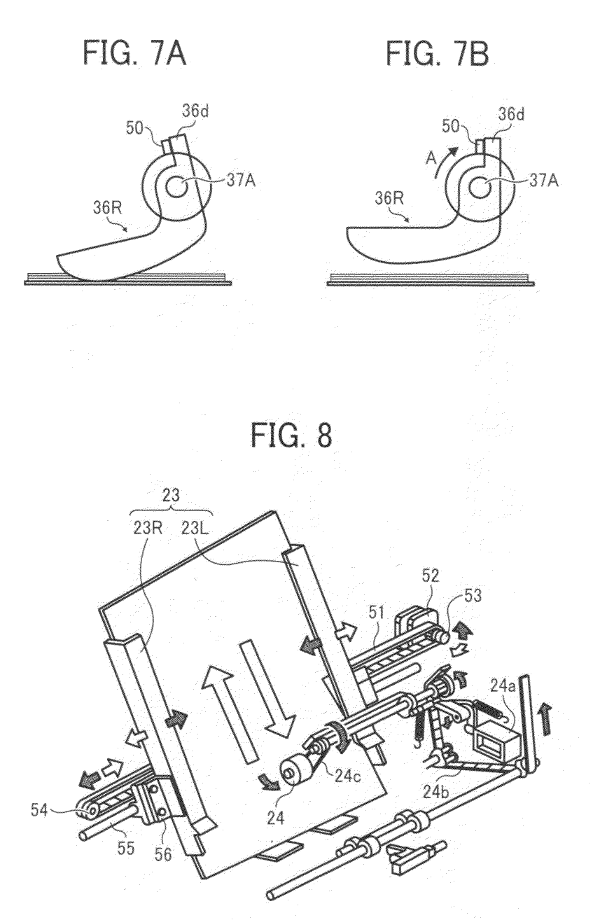

FIG. 5 is a perspective view illustrating a configuration of the auxiliary fence 36 included in the transverse jogger 23 in the present embodiment. FIG. 6 is a perspective view illustrating main components of a driving system 400 to drive the auxiliary fence 36, and FIGS. 7A and 7B illustrate movement of one of a right fence 36R and a left fence 36L of the auxiliary fence 36.

In the configuration shown in FIG. 5, a right jogger 23R and a left jogger 23L together form the transverse jogger 23, and the right fence 36R and the left fence 36L together form the auxiliary fence 36.

As shown in FIG. 5, the right jogger 23R and the left jogger 23L are partly cut away, and the right fence 36R and the left fence 36L are respectively plate-like members formed with, for example, the pieces cut from the right jogger 23R and the left jogger 23L. The right fence 36R and the left fence 36L are provided inside the cutouts of the right jogger 23R and the left jogger 23L and can be flipped up. More specifically, the right fence 36R and the left fence 36L of the auxiliary fence 36 can be rotated vertically around the swing axis 37 represented by dotted lines shown in FIG. 5 and be moved in the transverse direction or width direction indicated by arrow B shown in FIG. 5 by the driving system 400 shown in FIG. 6. Additionally, the right fence 36R and the left fence 36L of the auxiliary fence 36 are substantially L-shaped in the front view shown in FIG. 2, and their lower edge surfaces 36a are substantially in parallel to sheet receiving faces 23a of the right jogger 23R and the left jogger 23L of the transverse jogger 23. With this configuration, contact surfaces 36b of the right and left fences 36R and 36L contact side edge portions of the batch of sheets, respectively, thus aligning the batch of sheets. In FIG. 5, reference character 23b represents a side wall of each of the right jogger 23R and left jogger 23L.

The driving system 400 for the auxiliary fence 36 is described below with reference to FIG. 6. As shown in FIG. 6, the driving system 400 includes a swing shaft 37A to support the auxiliary fence 36 swingably around the swing axis 37 (shown in FIG. 5), a vertical driving motor 40 serving as a driving source to rotate the auxiliary fence 36 round the swing shaft 37A, a transverse driving motor 41 to move the auxiliary fence 36 in the width direction indicated by arrow B, a main driving belt 42, gears 43, and a relay belt 44. The main driving belt 42 transmits the driving force of the transverse motor 41 via the gears 43 to the relay belt 44, and the relay belt 44 transmits the driving force to bases 36-1 engaging the right fence 36R and the left fence 36L, respectively, thus causing the auxiliary fence 36 to execute transverse alignment.

The pair of the right fence 36R and the left fence 36L approach and move away from each other, driven by the main driving belt 42 and the relay belt 44. Each base 36-1 slides along two slide bars 36c, and accordingly the right fence 36R and the left fence 36L move along the swing shaft 37A together with the respective bases 36-1 in the width direction. The driving system 400 further includes a transverse movement lever 50 that is rotated by the vertical driving motor 40, and the auxiliary fence 36 swings vertically, that is, in a direction perpendicular to the surface of the sheets, as the transverse movement lever 50 rotates. The vertical movement lever 50 is fitted around an outer circumferential surface of the swing shaft 37A and is driven by the vertical driving motor 40.

Additionally, first and second position detectors 45 and 46 are provided to detect home positions of the auxiliary fence 36.

The first and second position detectors 45 and 46 are light transmissive sensors, which are so-called photo-interrupters, and respectively detect a first filler 47 projecting outside from the base 36-1 on the left in FIG. 6 in the width direction and a second filler 48 projecting from an outer circumference of the transverse movement lever 50. It is to be noted that, in the present embodiment, the auxiliary fence 36 is at the home position in the width direction as well as in the vertical direction when the first and second positional detectors 45 and 46 respectively detect the first and second fillers 47 and 48.

FIG. 7A illustrates the right fence 36R of the auxiliary fence 36 at an aligning position, and FIG. 7B illustrates the right fence 36R positioned away from the sheets. As shown in FIGS. 7A and 7B, a projection 36d is provided on an edge portion opposite the lower edge surface 36a (shown in FIG. 5). The auxiliary fence 36 operates as follows. For example, when the auxiliary fence 36 is at the aligning position shown in FIG. 7A, the vertical driving motor 40 rotates the vertical movement lever 50 clockwise, which is the direction indicated by arrow A shown in FIG. 7B. Then, the vertical movement lever 50 engages the projections 36d provided on the auxiliary fence 36, rotating the auxiliary fence 36 in the direction indicated by arrow A shown in FIG. 7B, and thus the auxiliary fence 36 is moved away from the sheets as shown in FIG. 7B. When the vertical driving motor 40 rotates in the reverse direction from the state shown in FIG. 7B, the auxiliary fence 36 descends to the position shown in FIG. 7A.

The amount by which the auxiliary fence 36 is moved in the width direction (e.g., transverse travel distance) from the home position, at which the first positional detector 45 detects the first filler 47, is adjusted by controlling the driving amount or step number of the transverse driving motor 41. Similarly, the amount by which the auxiliary fence 36 is moved in the vertical direction (e.g., vertical travel distance) from the home position, at which the second positional detector 46 detects the second filler 48, is adjusted by controlling the driving amount or step number of the vertical driving motor 40.

Sheet alignment by the transverse jogger 23 including the above-described auxiliary fence 36 is described below.

When cover sheets (e.g., a front cover and a back cover) 60 serving as a first sheet and a third sheet, respectively, are larger than sheets 61 serving as a second sheets to be inserted therebetween (hereinafter also “inserted sheets 61”), initially the auxiliary fence 36 is rotated upward around the swing shaft 37A before the aligning tray 22 receives the front cover 60, and then the side walls 23b of the transverse jogger 23 adjust the position of the front cover 60 on the aligning tray 22. Subsequently, the inserted sheets 61 are stacked on the front cover 60 on the aligning tray 22. More specifically, the auxiliary fence 36 descends until the lower edge surfaces 36a of the right fence 36R and the left fence 36L contact the front cover 60. In this state, the inserted sheets 61 are aligned in the width direction one at a time. As each inserted sheet 61 is stacked on the front cover 60, the right fence 36R and left fence 36L move in the width direction indicated by arrow B shown in FIG. 6 so that their contact surfaces 36b contact the respective edges of the inserted sheet 61. Thus, the multiple inserted sheets 61 are sequentially stacked and aligned on the aligning tray 22.

It is to be noted that the front cover 60 and the inserted sheets 61 are aligned with each other on the bound side in the present embodiment.

Subsequently, the position of the auxiliary fence 36 is adjusted to accommodate the back cover 61 that is also larger then the inserted sheets 61 although the back cover 60 is also to be aligned with the inserted sheets 61 on the bound side. In other words, the standby position of the auxiliary fence 36 is shifted outside for a predetermined distance, and the auxiliary fence 36 perform alignment operation from that position. Thus, the transverse jogger 23 including the auxiliary fence 36 can align the front and back covers 60 and the inserted sheets 61 smaller than the covers 60 as a batch of sheets. It is to be noted that the transverse jogger 23 (23R and 23L) and the auxiliary fence 36 (36R and 36L) can move separately.

FIG. 8 is a perspective view illustrating a driving system of the transverse jogger 23. It is to be noted that the auxiliary fence 36 is omitted in FIG. 8 for simplicity.

In FIG. 8, the driving system of the transverse jogger 23 includes a slide bar 55 extending in the width direction perpendicular to the sheet transport direction and a pair of slide guides 56 respectively attached to an outer side surface of the right jogger 23R and the left jogger 23L. The slide bar 55 slidably supports the right jogger 23R and the left jogger 23L via the respective slide guides 56.

The driving system further includes a timing belt 51 stretched between a driving pulley 53 and a driven pulley 54, and a jogger driving motor 52 coaxial to the driving pulley 53. The slide guides 56 are respectively connected to an upper side and a lower side of the timing belt 51 and move back and forth in the width direction (indicated by arrow B in FIG. 5) symmetrically along the slide bar 55 as the jogger driving motor 52 rotates in a normal direction and in the reverse direction. Accordingly, the right and left joggers 23R and 23L of the transverse jogger 23 move toward and away from each other as the alignment operation. Moving the transverse jogger 23 to an aligning position according to the sheet size and to a standby position is controlled by controlling the jogger driving motor 52 according to detection by a home position sensor, not shown. This control can be similar to the control of the auxiliary fence 36.

Additionally, as shown in FIG. 8, the roller 24 is disposed between the right jogger 23R and the left jogger 23L. The roller 24 contacts the sheet and moves away from the sheet as a solenoid 24a is switched between on and off. As a driving motor, not shown, drives a timing belt 24b, a rotary shaft (not shown) connected to the timing belt 24b rotates, which further rotates an arm 24c attached to the roller 24. Thus, the roller 24 rotates to push the sheet down in FIG. 8 to the fence, not shown, thus aligning the sheet in the sheet transport direction.

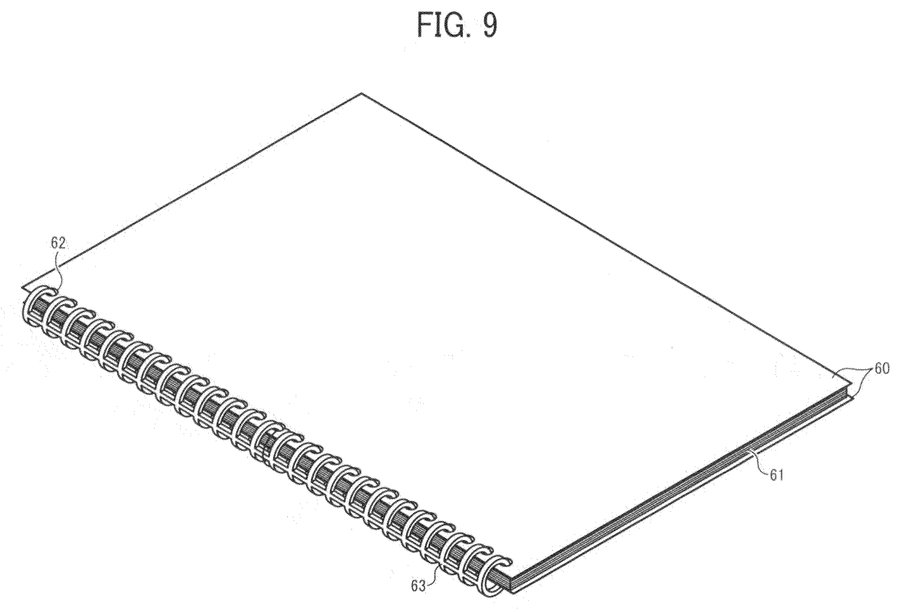

FIG. 9 is a perspective view illustrating an appearance of a book produced by the ring-binding device 7 according to the present embodiment.

As shown in FIG. 9, the multiple ring holes 62 are formed in the covers 60 and the sheets 61 inserted therebetween, and the covers 60 and the sheets 61 are bound together with a ring member 63 into a book (hereinafter “ring-bound book”). As shown in FIG. 9, the front and back covers 60 are larger than the inserted sheets 61.

It is to be noted that, in the present embodiment, when the covers 60 are larger than the inserted sheets 61 in both the sheet transport direction and the width direction, the covers and the inserted sheets 61 are aligned with each other on the side to be bound (bound side) while the covers 60 project from the inserted sheets 61 on other three sides.

Additionally, in the present embodiment, the punch unit 16 may punch each sheet with a center of a line of ring holes 62 either substantially aligned with or deviated from a center of the bound side of the sheet, which is achieved by controlling the jogger 14 to set relative positions of the center of the line of ring holes 62 and the center of the bound side of the sheet.

More specifically, the jogger 14 serves as a punch positioning unit to set the position of each sheet before punching in a transverse direction or width direction, in which the line of ring holes 62 are arranged. The jogger 14 includes a right jogger and a left jogger driven by different driving sources, and the right jogger and the left jogger can be positioned separately regardless of the center of the sheet in the width direction. With this configuration, the center of the line of ring holes 62 can be deviated from the center of the sheet.

When the center of a line of ring holes 62 is substantially aligned with the center of the bound side of the sheet, centers of the covers 60 and the inserted sheets 61 in the sheet transport direction can be substantially aligned with each other. Accordingly, the ring-bound book can have a good appearance.

Alternatively, the punch unit 16 punches each sheet with the center of the line of ring holes 62 deviated from the center of the bound side of the sheet. For example, one of the two sides in parallel to the sheet transport direction is set as a reference side, and the larger sheet (cover 60) and the smaller sheet (inserted sheet 61) can be set on the aligning tray 13 so that the distance from the reference side (reference end) to the ring hole 62 closest to the reference side is identical or similar in both the larger sheet and the smaller sheet. When the ring-bound book in which the reference end of the larger sheet is aligned with that of the smaller sheet stands on the reference end on a bookshelf or the like, the bottoms of both the larger sheet and the smaller sheet can contact the surface of the bookshelf. Thus, the position of the smaller sheet can be kept reliably when the ring-bound book stands on its end. As described above, by shifting the position of the ring holes 62, various ring binding can be attained.

Additionally, the ring-binding device 7 can be configured so that following operations can be selected when the sizes of the covers 60 and the inserted sheets 61 are different.

1) Ring binding is executed.

2) Alignment is executed but ring binding is not executed.

3) Punching is executed but ring binding is not executed.

Thus, users can select multiple operations according to the intended use of the batch of sheets to be bound together.

As described above, in the present embodiment, ring binding can be performed even when the lengths of the covers 60 and the sheets 61 in at least one of the sheet transport direction and the width direction perpendicular to the sheet transport direction are different.

Numerous additional modifications and variations are possible in light of the above teachings. It is therefore to be understood that, within the scope of the appended claims, the disclosure of this patent specification may be practiced otherwise than as specifically described herein.

What is claimed is:

1. A bookbinding device to bind together multiple sheets of recording media including a first sheet and a second sheet smaller than the first sheet in a width direction perpendicular to a sheet transport direction in which the sheets are transported,
the bookbinding device comprising:
a punch unit to form a line of ring holes in a predetermined portion along a side of a respective one of the multiple sheets;
an aligning unit disposed downstream from the punch unit in the sheet transport direction, to align the multiple sheets punched by the punch unit in the width direction;
the aligning unit including:
a pair of first aligning members each including a sheet loading surface to support the multiple sheets and a side wall perpendicular to the sheet loading surface, to align the first sheet by contacting a side edge portion of the first sheet in parallel to the sheet transport direction,
a pair of second aligning members, each including a lower surface facing the sheet loading surface of the first aligning member and a contact surface perpendicular to the lower surface,
the contact surface aligning the second sheet smaller than the first sheet by contacting a side edge portion of the second sheet in parallel to the sheet transport direction, and
a swing shaft extending perpendicular to the sheet transport direction, rotatably supporting the second aligning members;
a first driving source to rotate the second aligning members away from the sheet loading surfaces of the first aligning members when the first aligning members align the first sheet and to rotate the second aligning members toward the sheet loading surfaces of the first aligning members when the second aligning members align the second sheet; and
a ring-binding unit disposed adjacent to the aligning unit, to insert rings of the ring member into the ring holes formed in the multiple sheets.

2. The bookbinding device according to claim 1, wherein the first aligning members move in the width direction to align the first sheet, and the second aligning members move in the width direction to align the second sheet.

3. The bookbinding device according to claim 1, wherein the first sheet is a cover sheet, and the second sheet is inserted between the first sheet and a third sheet.

4. The bookbinding device according to claim 3, wherein the second aligning members align the second sheet stacked on the first sheet.

5. The bookbinding device according to claim 4, wherein the third sheet is larger than the second sheet, and the second aligning members align the third sheet stacked on the second sheet.

6. The bookbinding device according to claim 5, wherein the first sheet and the third sheet are larger than the second sheet in the sheet transport direction in addition to the width direction.

7. The bookbinding device according to claim 1, wherein each of the second aligning members of the aligning unit is substantially L-shaped.

8. The bookbinding device according to claim 1, wherein the second aligning members are disposed inside the first aligning members.

9. The bookbinding device according to claim 8, wherein each of the first aligning members is partly cut away to form a cutout, and each of the second aligning members is a plate-like member disposed inside the cutout of the respective one of the first aligning members.

10. The bookbinding device according to claim 1, wherein the line of ring holes punched by the punch unit is perpendicular to the sheet transport direction.

11. The bookbinding device according to claim 1, further comprising a punch positioning unit disposed upstream from the punch unit in the sheet transport direction, to set a position of the respective one of the multiple sheets in a direction parallel to the line of ring holes before punching.

12. The bookbinding device according to claim 11, wherein the punch unit punches the respective one of the multiple sheets positioned by the punch positioning unit with a center of the line of ring holes substantially aligned with a center of the sheet in the direction in which the ring holes are arranged.

13. The bookbinding device according to claim 11, wherein the punch unit punches the respective one of the multiple sheets positioned by the punch positioning unit with a center of the line of ring holes deviated from a center of the sheet in the direction in which the ring holes are arranged.

14. The bookbinding device according to claim 1, further comprising a pin member that includes a pin extending vertically to the sheet loading surface of the first aligning member of the aligning units,
wherein the pin is movable vertically and penetrates one of the line of ring holes formed in the multiple sheets to align the multiple sheets relative to the line of ring holes.

15. A bookbinding system including an image forming apparatus to form an image on a sheet and a bookbinding device to bind together multiple sheets of recording media including a first sheet and a second sheet smaller than the first sheet in a width direction perpendicular to a sheet transport direction in which the sheets are transported,
the bookbinding device comprising:
a punch unit to form a line of ring holes in a predetermined portion along a side of the respective one of the multiple sheets;
an aligning unit disposed downstream from the punch unit in the sheet transport direction, to align the punched multiple sheets in the width direction;
the aligning unit including:
a pair of first aligning members each including a sheet loading surface to support the multiple sheets and a side wall perpendicular to the sheet loading surface, to align the first sheet by contacting a side edge portion of the first sheet in parallel to the sheet transport direction,
a pair of second aligning members disposed inside the first aligning members in the width direction, each including a lower surface facing the sheet loading surface of the first aligning member and a contact surface perpendicular to the lower surface,
the contact surface aligning the second sheet smaller than the first sheet by contacting a side edge portion of the second sheet in parallel to the sheet transport direction, and
a swing shaft extending perpendicular to the sheet transport direction, rotatably supporting the second aligning members;
a driving source to rotate the second aligning members away from the sheet loading surfaces of the first aligning members when the first aligning members align the first sheet and to rotate the second aligning members toward the sheet loading surfaces of the first aligning members when the second aligning members align the second sheet; and
a ring-binding unit disposed adjacent to the aligning unit, to insert rings of the ring member into the ring holes formed in the multiple sheets.

16. A method of binding together multiple differently-sized sheets using a bookbinding device comprising a punch unit, a pair of first aligning members, and a pair of second aligning members disposed inside the first aligning members in a width direction perpendicular to a direction in which the multiple sheets are transported,
the method comprising:
forming a line of ring holes in a predetermined portion along a side of a respective one of the multiple sheets;
rotating the second aligning members upward;
aligning a first sheet in the width direction using the first aligning members;
rotating the second aligning members downward;
stacking a second sheet smaller than the first sheet on the aligned first sheet;
aligning the second sheet in the width direction using the second aligning members; and
binding together the multiple sheets with a ring member.

17. The method according to claim 16, further comprising aligning the multiple sheets relative to the line of ring holes by inserting a pin member at least one of the line of ring holes of the multiple sheets stacked one on another.
